(19) United States
(12) Patent Application Publication
(10) Pub. No.: US 2005/0224464 A1
(43) Pub. Date: Oct. 13, 2005

(54) Getter device for vacuum circuit breaker

(76) Inventors: Martin Bernardus Johannes Leusenkamp, Hengelo (NL); Johannes Hermannus Laurentius Antonius Hilderink, Haaksbergen (NL)

Correspondence Address: Kirk D Houser;Eckert Seamans Cherin & Mellott, 44th Floor, 600 Grant Street, Pittsburgh, PA, 15219, US

(21) Appl. No.: 10/508,240

(22) PCT Filed: Mar. 21, 2003
(86) PCT No.: PCT/NL03/00215

§ 371 Date: Mar. 21, 2005

(30) Foreign Application Priority Data
Mar. 21, 2002 (NL) 1020223

(51) Int. Cl. H01H 33/66

(52) U.S. Cl. 218/120

(57) ABSTRACT

Getter device for positioning in a vacuum interior space (12) of a vacuum circuit breaker (10). The getter device comprises at least one tablet (2) of getter material. The interior space (12) comprises a metal wall (13, 16. 11, 17, 19, 21) with a groove (4) in which the at least one tablet (2) can be placed, and the at least one tablet (2) can be fixed by at least one depression in an edge (7; 9) of the groove (4). The metal wall may be formed by a contact pin (13, 16) of one of the contacts (14, 15) or a wall of the enclosure, which comprises an end cap (11), a first shielding (17), a second shielding (19) or a second end cap (21).

The present invention relates to a getter device to be placed in a vacuum interior space of a vacuum circuit breaker.

In vacuum circuit breakers which are provided with a fixed contact and a moving contact and an enclosure which surrounds the contacts, it is customary for the vacuum circuit breaker to be provided with a getter device. This getter device is used to absorb gases which during operation, i.e. when the vacuum circuit breaker is being switched on and off, may be released and/or diffused through the enclosure and have an adverse effect on the quality of the vacuum.

A getter device of this type is known, for example, from German utility model DE-U 297 04 327. This device makes use of a carrier in ribbon form which consists of a certain material, such as nickel-coated iron or constantan, to both sides of which the getter material, such as zirconium-aluminum (ZrAl) or zirconium-vanadium-iron (ZrVFe) is applied. The carrier in ribbon form is placed into the vacuum tube in a suitable size. If a material which is made from (stainless) steel is present inside the vacuum circuit breaker, it is easy to secure the carrier in ribbon form made from tin plate inside the vacuum circuit breaker by, for example, spot welding. However, if the material in the vacuum tube consists of a material which cannot be welded or is difficult to weld, such as copper or a copper alloy, it is not possible to secure the carriers in the vacuum circuit breaker with the aid of welding techniques. In the getter device which is known from DE-U 297 04 327, the carrier in ribbon form is arranged in a shallow groove which is formed, for example, on the material on the inner side of the vacuum circuit breaker or on the outer side of the contact carriers. The carrier in ribbon form is placed in the groove and fixed in it as a result of the edges of the groove being depressed at the location of the carrier in ribbon form.

This known getter device has the drawback of using a relatively expensive ribbon with getter material. In addition, the positioning of the ribbon against a shallow groove means that in fact only half the getter material is effectively used, since only one half of the carrier in ribbon form is in contact with the interior of the vacuum circuit breaker.

The other half is relatively inaccessible to the gases which are to be absorbed, also on account of vaporized impurities resulting from the soldering process. The absorption of the gases in the interior space of the vacuum circuit breaker is therefore relatively slow. To improve this, it is necessary to use a larger piece of ribbon, which entails higher costs. Also, a longer groove or a groove which runs over the entire periphery constitutes a drawback at high currents, since the effective current carrying diameter is reduced. Also, a longer groove entails higher production costs.

Therefore, it is an object of the present invention to provide a getter device which allows more efficient use of the getter material.

According to the present invention, to this end a getter device of the type defined in the preamble is provided, in which the getter device comprises at least one tablet of getter material, the interior space comprises a metal wall with a groove in which the at least one tablet can be placed, and the at least one tablet can be fixed by at least one session in an edge of the groove.

This getter device has the advantage that the getter material is used more efficiently, and consequently less getter material has to be used to attain a set life for the vacuum in the vacuum circuit breaker. Furthermore, the use of small tablets of getter material is less expensive than the use of a carrier ribbon with a layer of getter material thereon.

In one embodiment of the present invention, the interior space is formed by an enclosure in which a fixed contact and a moveable contact are positioned, and the groove is arranged in a wall inside the vacuum circuit breaker. This results in a getter device which, by means of a minor intervention, is easy to fit inside the vacuum circuit breaker, is inexpensive and offers an optimum absorption capacity for gases in the interior space of the vacuum circuit breaker. Since the use of the tablet material is more effective, it is also possible to make do with just a groove of limited dimensions, which is advantageous for higher currents.

In a further embodiment, the interior space is formed by an enclosure in which a fixed contact and a moveable contact are positioned, each comprising a contact body and a contact pin connected to the contact body, and the groove is arranged in the contact pin of the moveable contact. As a result of the current running through the contact pin, the getter material reaches a slightly higher temperature, which improves the action of the getter. In this embodiment it is also possible for the getter material to be positioned closer to the contact bodies of the vacuum circuit breaker where possible contaminations may arise, resulting in more effective operation of the getter device. Furthermore, there is also less loss of effective cross section of the contact pin, which is important in particular for relatively high currents. Moreover, this embodiment is also possible if a vacuum circuit breaker with a thin wall (less than 2 mm) is used.

In yet another embodiment, the interior space is formed by an enclosure in which a fixed contact and a moveable contact are positioned, each comprising a contact body and a contact pin connected to the contact body, and the groove is arranged in the contact pin of the fixed contact. In this embodiment, not only is the getter material positioned closer to the location where contamination may form, but also the getter device is more robust because the getter material does not move when the vacuum circuit breaker is operating. The position behind the contact body is preferred, since it generally also has the advantage that the surface of the getter material cannot easily be contaminated by, for example, the metal vapor which forms when the contacts are being broken or closed.

In a preferred embodiment, the groove has a shape which substantially corresponds to the dimensions of the at least one tablet. If necessary, this groove can be formed a number of times in both the axial direction and the radial direction. The axial direction is preferred, since shortening the contact pin in the axial direction has no effect on the getter material, since the latter has some space in the longitudinal direction of the groove. Matching the groove dimensions to those of the tablet means that the minimum possible amount of material has to be removed from the wall by, for example, milling, so that the wall remains more robust and costs less to machine. Also, there is therefore no narrowing of the material, making it possible to avoid problems at high currents and also meaning that no unnecessary heat is generated.

In a further embodiment, the groove is elongate and in cross section is in the shape of a trapezoid, an opening of the groove having a smaller dimension than a rear wall of the groove. As a result of an opening also being provided in the slot with dimensions which substantially correspond to dimensions of the at least one tablet, it is possible for one or more tablets to be pushed into the slot in a simple way. As soon as the tablets required have been fitted, they can be fixed in place by depressing the edge of the slot. There is then only one operation required to fix a plurality of tablets in place. Obviously, this embodiment is also suitable for getter materials which are designed in other than tablet form.

If the tablet is placed in a groove in one of the contact pins, it is advantageous for the longitudinal direction of the groove to coincide with the direction in which the highest forces occur, such as the longitudinal direction of the contact pin, the highest forces occurring when the contact bodies are being closed (and held closed).

The groove can be formed in a simple way in the wall or the contact pins by means of a cold-forming or hot-forming process.

All the above forms provide the maximum advantage over the prior art if the end caps, the shieldings, the moveable contact and/or the fixed contact are made from copper or a copper alloy.

The present invention will be explained in more detail below on the basis of a number of exemplary embodiments and with reference to the appended figures, in which:

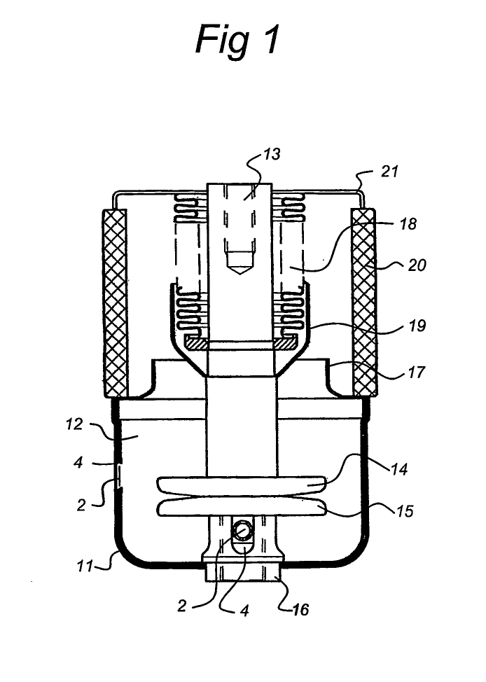

FIG. 1 shows a cross-sectional view through part of a vacuum circuit breaker, provided with a getter device according to the present invention;

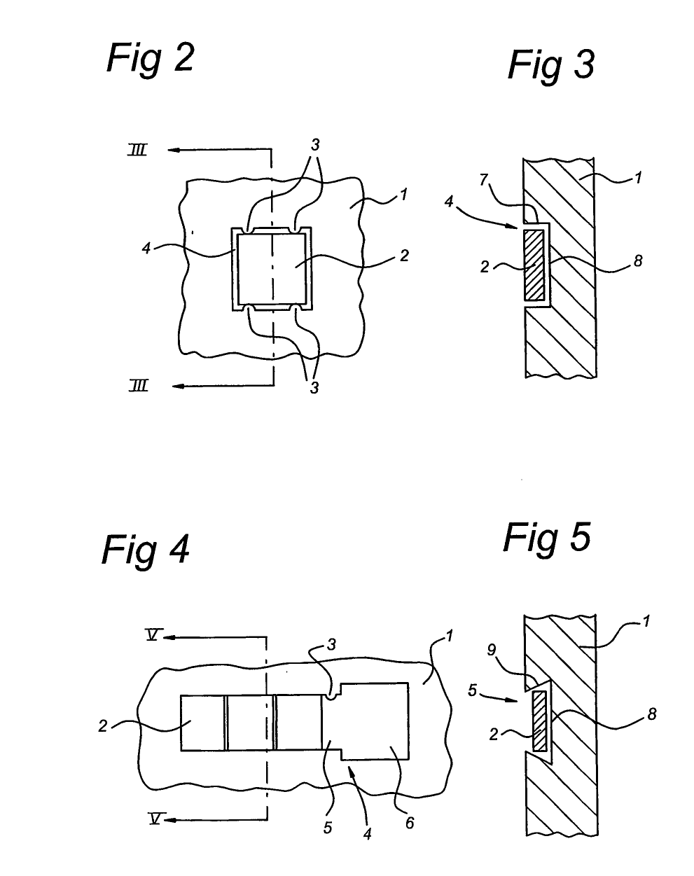

FIG. 2 shows a partial front view of a getter device according to a first embodiment of the present invention;

FIG. 3 shows a partial cross-sectional view through the getter device shown in FIG. 1 on line III-III in FIG. 2;

FIG. 4 shows a partial front view of a getter device according to a second embodiment of the present invention;

FIG. 5 shows a partial cross-sectional view through the getter device shown in FIG. 4 on line V-V in FIG. 4.

FIG. 1 shows a cross-sectional view through a possible embodiment of a vacuum circuit breaker 10 which is provided with a getter device according to the present invention. The vacuum circuit breaker 10 has a vacuum interior space 12 which is surrounded by an enclosure. This enclosure is made from an insulating material such as ceramic or, depending on the embodiment, from a combination of ceramic and metal. The enclosure is formed by a first end cap 11, a ceramic sleeve 20 and a second end cap 21. A vacuum circuit breaker 10 as used in vacuum switches generally comprises a vacuum interior space 12 which comprises a fixed contact 15 and a moveable contact 14 (also known as contact bodies). The fixed and moveable contacts 15, 14 are supported and driven by a fixed contact pin 13 and a moveable contact pin 16, respectively. In the enclosure there is a first shielding 17 made from copper or steel which is connected to the first end cap 11. In the enclosure there is also a second shielding 19 which shields a bellows 18, the bellows 18 enabling the moveable contact 14 to move with respect to the enclosure while retaining the vacuum in the interior space 12. The second shielding 19 is also made from copper or steel, for example. Other embodiments are also possible in which, for example, the ceramic sleeve 20 extends over the entire length of the vacuum circuit breaker 10. In this case, a further shielding is often arranged at the contacts 14, 15.

When the switch is closed, the fixed and moveable contacts 15, 14 make contact with one another. When the vacuum circuit breaker 10 is switched off, the two contacts 14, 15 are pulled apart. If the vacuum circuit breaker is carrying current at that time, a metal vapor arc will form. In principle, the current will be interrupted at the first current zero crossing, with the result that no further vapor is produced. Contact erosion may lead to microcavities containing gas being exposed, which may have an adverse effect on the vacuum integrity. In fact, there is gas in the material, and oxidation also produces gas and gas is formed as a result of the arc across the surface. As a result, it is possible that gases which may have an adverse effect on the vacuum of the vacuum circuit breaker 10 may develop. Although the metal vapors generated also, as it were, fix absorbed gas particles to the walls in the interior of the vacuum interior space, this problem is resolved in particular by arranging what is known as a getter device in the vacuum interior space 12 of the vacuum circuit breaker 10.

Although there are both evaporating and non-evaporating (NEGs) getter materials, for vacuum circuit breakers it is preferable to use non-evaporating getter materials. In this case, the getter device comprises absorbent material, generally a zirconium-aluminum or zirconium-vanadium-iron alloy which is able to absorb the gases formed, with the result that the vacuum level is maintained. In conventional vacuum circuit breakers 10, use was made of a carrier, for example in the form of a ribbon, to which the getter material was applied and which was provided with slots making it easy to divide the ribbon into smaller pieces. The carrier was then welded or soldered to a metal surface in the vacuum interior space 12.

However, use is increasingly being made of copper and/or copper alloys and/or other materials which are difficult or impossible to weld or solder for the shieldings or end caps in the enclosure of the vacuum interior space 12. Welding or soldering of the getter device is then no longer possible or very difficult, since mechanical stresses and corrosion may occur. A solution was found by arranging an encircling slot at the end cap or the shielding in the enclosure 11 or on the outer side of one of the contact pins 13, 16, in which slot the carrier in ribbon form can be positioned and fixed by depressing the edge of the slot. However, in this way only half of the getter material (on one side of the carrier in ribbon form) is used. Furthermore, the use of getter material which is arranged on a carrier in ribbon form is expensive and the structure is not robust.

The invention provides a getter device by positioning tablets 2 of getter material in a slot 4 in a metal wall of the enclosure of the interior space 12 of the vacuum circuit breaker 10. The metal wall can be formed by the end cap 11, the first shielding 17, the second shielding 19 or one of the contact pins 13, 16.

FIG. 2 shows a first embodiment of a getter device according to the present application. The present getter device makes use of getter material which has been shaped into small sintered tablets 2, for example obtained from the zirconium-aluminum or zirconium-vanadium-iron material. To achieve a comparable effectiveness in terms of maintaining a defined vacuum level, these tablets are less expensive by a factor of 10 than a carrier in ribbon form with getter material.

The tablets 2 are arranged on small metal strips and are commercially available and are used in many fields. The tablets are generally secured to a metal surface by spot-welding. Spot-welding of the tablets 2 is not possible in modern vacuum circuit breakers 10 with an enclosure inside which there are only copper or copper alloy materials.

According to the invention, a groove 4 is formed in a wall 1 of the interior space of the vacuum circuit breaker. The wall 1 may, for example, be the surface of a shielding 11, 17, 19 or an end cap 11, 21 inside the enclosure, or an outer wall of one of the contact pins 13, 16. In the embodiment shown in FIG. 2, the groove 4 is a straight recess in the wall 1 with side walls 7 positioned at right angles to the wall 1. The dimensions of the groove 4 are substantially equal to the dimensions of a tablet 2, so that the tablet can easily be placed in the groove 4. FIG. 3 shows a cross section through the section of the wall 1 on line III-III in FIG. 2.

The tablet is easy to fix in the groove 4 as a result of the edge of the groove 4 being depressed at a number of locations, as indicated by reference numeral 3. FIG. 2 shows that the tablet is fixed by two depressions 3 on the top side and two on the underside. Obviously, it is possible for the tablet 2 to be fixed at other locations and using different numbers of depressions 3. The depressions 3 can be produced in various ways, for example by pressing onto an edge 7 of the groove 4 with force or by deforming the material of the edge 7 by, for example, heating.

FIG. 4 shows another embodiment of the getter device according to the present invention. In this embodiment, the slot 4 is elongate in shape, with two sections 5, 6, of which the first section 5 has an opening with a width which is smaller than the width of a tablet 2. The second section has dimensions which are substantially equal to the dimensions of the tablet 2. FIG. 5 shows a cross-sectional view through the getter device shown in FIG. 4 on line V-V. It is clearly apparent from this figure that the first section 5 of the elongate slot 4 is in the shape of a trapezoid in cross section, the opening of the slot 4 having a smaller dimension than the rear wall 8 of the slot 4. This allows the tablet 2 first of all to be positioned in the second section 6 and then the tablet 2 to be moved into its final position in the first section 5. The first section 5 of the slot 4 has an edge 9 which is positioned obliquely with respect to the perpendicular to the wall 1, so that the tablet 2 is held in place. When the tablet 2 is in its intended position in the first section 5, the tablet can be fixed in place by one or more depressions 3. In this embodiment, it is possible to arrange a plurality of tablets in a slot 4. It will be clear that the slot 4, in cross section, may also have shapes other than a trapezoid shape, such as a stepped shape.

The slot 4 may be arranged in the inner wall 1 of the enclosure 11 of a vacuum circuit breaker 10, even if the latter is made from copper or a copper alloy. However, the slot 4 may also be arranged in an outer wall 1 of one of the contact pins 13, 16 or even on the contacts 14, 15 of the vacuum circuit breaker 10. This has the advantage that the tablet 2 can be arranged closer to the location where any contaminating gases are formed, namely close to the location where the contacts 14, 15 are in contact with one another.

Even more preferably, the slot 4 and the tablets 2 are arranged in the outer wall 1 of the fixed contact pin 16 or beneath the fixed contact 15 of the vacuum circuit breaker. The fact that the fixed contact 15, 16 does not move means that the structure of the getter device will be more robust and there will be less risk of a tablet 2 becoming detached through impacts or other external influences.

To prevent the possibility of the small strips to which the tablets are secured being deformed by deformation during switching in the case of relatively thin contact pins, which may cause them to become detached from the slot, the longitudinal direction of the slot 4 is preferably positioned parallel to the direction in which the highest forces occur, in this case the longitudinal direction of the contact pin 16.

It will be clear to the person skilled in the art that the embodiments shown above are merely examples of the present invention. Numerous variants which are covered by the scope of protection as defined by the appended claims are possible.

1. Getter device for positioning in a vacuum interior space of a vacuum circuit breaker, characterized in that the getter device comprises at least one tablet of getter material, the interior space comprises a metal wall with a groove in which the at least one tablet can be placed, and the at least one tablet can be fixed by at least one depression in an edge of the groove.

2. Getter device as claimed in claim 1, in which the interior space is formed by an enclosure in which a fixed contact and a moveable contact are positioned, and the groove is arranged in a wall inside the vacuum circuit breaker.

3. Getter device as claimed in claim 1, in which the interior space is formed by an enclosure in which a fixed contact and a moveable contact are positioned, each comprising a contact body and a contact pin connected to the contact body, and the groove is arranged in the contact pin of the moveable contact.

4. Getter device as claimed in claim 1, in which the interior space is formed by an enclosure in which a fixed contact and a moveable contact are positioned, each comprising a contact body and a contact pin connected to the contact body, and the groove is arranged in the contact pin of the fixed contact.

5. Getter device as claimed in claim 1, in which the groove has a shape which substantially corresponds to the dimensions of the at least one tablet.

6. Getter device as claimed in claim 1, in which the groove is elongate and in cross section is in the shape of a trapezoid, an opening of the groove having a smaller dimension than a rear wall of the groove.

7. Getter device as claimed in claim 3, in which the longitudinal direction of the groove runs parallel to the direction of the contact pin in which the highest forces occur.

8. Getter device as claimed in claim 1, in which the groove is produced by means of a cold-forming or hot-forming process.

9. Getter device as claimed in claim 1, in which the end caps, the shieldings, the fixed contact and/or the moveable contact are made from copper or a copper alloy.

10. Getter device as claimed in claim 2, in which the groove has a shape which substantially corresponds to the dimensions of the at least one tablet.

11. Getter device as claimed in claim 3, in which the groove has a shape which substantially corresponds to the dimensions of the at least one tablet.

12. Getter device as claimed in claim 4, in which the groove has a shape which substantially corresponds to the dimensions of the at least one tablet.

13. Getter device as claimed in one of claim 2, in which the groove is elongate and in cross section is in the shape of a trapezoid, an opening of the groove having a smaller dimension than a rear wall of the groove.

14. Getter device as claimed in one of claim 3, in which the groove is elongate and in cross section is in the shape of a trapezoid, an opening of the groove having a smaller dimension than a rear wall of the groove.

15. Getter device as claimed in one of claim 4, in which the groove is elongate and in cross section is in the shape of a trapezoid, an opening of the groove having a smaller dimension than a rear wall of the groove.

16. Getter device as claimed in claim 4, in which the longitudinal direction of the groove runs parallel to the direction of the contact pin in which the highest forces occur.

17. Getter device as claimed in claim 5, in which the longitudinal direction of the groove runs parallel to the direction of the contact pin in which the highest forces occur.

18. Getter device as claimed in claim 6, in which the longitudinal direction of the groove runs parallel to the direction of the contact pin in which the highest forces occur.

19. Getter device as claimed in claim 2, in which the fixed contact and/or the moveable contact are made from copper or a copper alloy.

20. Getter device for positioning in a vacuum interior space of a vacuum circuit breaker, characterized in that the getter device comprises at least one tablet of getter material, the interior space comprises a metal wall with a groove in which the at least one tablet can be placed, the at least one tablet can be fixed by at least one depression in an edge of the groove, and the interior space is formed by an enclosure in which a fixed contact and a moveable contact are positioned, each comprising a contact body and a contact pin connected to the contact body, and the groove is arranged in the contact pin of one of the moveable contact and the fixed contact.
